(19) United States
(12) Patent Application Publication
(10) Pub. No.: US 2025/0094264 A1
(43) Pub. Date: Mar. 20, 2025

(54) System Cache Path To Enable Path-To-DDR Infrastructure Scan Dump During Device Crashes

(71) Applicant: QUALCOMM Incorporated, San Diego, CA (US)

(72) Inventors: Mohsin RIAZ, San Diego, CA (US); Tamer KAFAFI, San Diego, CA (US); Xavier Loic LELOUP, San Diego, CA (US); Mosaddiq SAIFUDDIN, San Diego, CA (US)

(21) Appl. No.: 18/470,333

(22) Filed: Sep. 19, 2023

(51) Int. Cl. G06F 11/07; G06F 9/30

(52) U.S. Cl. CPC G06F 11/0778; G06F 9/30043; G06F 11/0787

(57) ABSTRACT

Various embodiments include methods and devices for implementing a scan dump of memory subsystem cores. Embodiments may include enabling a scan dump path of the memory subsystem during a computing device crash reset flow, the scan dump path comprising at least one memory controller having at least one scan dump logic module, a scan dump network on chip (NoC) module, and at least one scan dump data bus connecting the at least one scan dump logic module and the scan dump NoC, and initializing a scan mode for a memory path of the memory subsystem and for a low power memory path of the memory subsystem.

### BACKGROUND

Complex computer chip design makes debugging issues resulting in a crash of a computing device complicated and time-consuming. For a computing device crash, debugging the issue can include dumping computer chip states to dynamic random access memory (DRAM) during a computing device crash reset flow. A means for dumping computer chip states includes reading scan chains of computing device intellectual property (IP) cores and storing the scan chain data to the DRAM. Accessing the DRAM for storing the scan chain data to the DRAM requires that memory subsystem component cores be functional. As such, the memory subsystem component cores cannot be scan dumped during the computing device crash reset flow and issues with the memory subsystem component cores cannot be debugged using scan using data gather during the computing device crash reset flow.

### SUMMARY

Various aspects provide methods include methods and apparatuses for implementing such methods for implementing a scan dump of memory subsystem cores. Aspects may include enabling a scan dump path of the memory subsystem during a computing device crash reset flow, the scan dump path including at least one memory controller having at least one scan dump logic module, a scan dump network on chip (NoC) module, and at least one scan dump data bus connecting the at least one scan dump logic module and the scan dump NoC, and initializing a scan mode for a memory path of the memory subsystem and for a low power memory path of the memory subsystem.

Some aspects may further include storing scan chain data of at least one core of the memory subsystem to a memory of the memory subsystem during the computing device crash reset flow following enabling the scan dump path of the memory subsystem during the computing device crash reset flow.

Some aspects may further include: reading the scan chain data of at least one core of the memory subsystem during the computing device crash reset flow following enabling the scan dump path of the memory subsystem during the computing device crash reset flow, and writing the scan chain data for the at least one core of the memory subsystem to a memory of the memory subsystem via the scan dump path of the memory subsystem during the computing device crash reset flow.

In some aspects, reading the scan chain data of the at least one core of the memory subsystem during the computing device crash reset flow following enabling the scan dump path of the memory subsystem during the computing device crash reset flow may include reading the scan chain data of the at least one core of the memory subsystem out of the memory subsystem, and writing the scan chain data for the at least one core of the memory subsystem to the memory of the memory subsystem via the scan dump path of the memory subsystem during the computing device crash reset flow may include writing the scan chain data for the at least one core of the memory subsystem to the memory of the memory subsystem via the scan dump path of the memory subsystem from out of the memory subsystem.

Some aspects may further include clearing at least one memory of the memory subsystem. Some aspects may further include indicating that the scan dump path is in an enabled state following enabling the scan dump path of the memory subsystem during the computing device crash reset flow and clearing the at least one memory of the memory subsystem.

Some aspects may further include identifying a condition for a scan dump of the memory subsystem, in which enabling the scan dump path of the memory subsystem during the computing device crash reset flow may be implemented following identifying the condition for the scan dump of the memory subsystem.

Some aspects may further include initializing a functional mode for the memory path of the memory subsystem and for the low power memory path of the memory subsystem while retaining scan chain data of at least one core of the memory subsystem at a memory of the memory subsystem.

In some aspects, the memory subsystem cores may include at least one of at least one memory controller module, at least one cache controller module, a memory NoC module, a low power NoC module, at least one memory logic module, at least one low power logic module, or at least one cache.

Further aspects include a computing device including a memory and a processor and/or memory frequency device configured to perform operations of any of the methods summarized above. Further aspects include a non-transitory processor-readable storage medium having stored thereon processor-executable software instructions configured to cause a processor and/or memory frequency device to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIGS. 2A-2D are component block diagrams illustrating an example memory subsystem of the computing device suitable for implementing various embodiments.

FIG. 3 is a state and flow diagram illustrating an example of a state machine process for implementing a scan dump path in the memory subsystem suitable for implementing various embodiments.

FIG. 4 is a state and flow diagram illustrating an example of a state machine process for implementing the scan dump path in the memory subsystem suitable for implementing various embodiments.

FIG. 5 is a process flow diagram illustrating an example method for implementing a scan dump of memory subsystem cores via the scan dump path in the memory subsystem according to an embodiment.

FIG. 6 is a process flow diagram illustrating an example method for implementing configuration of the memory subsystem for implementing the scan dump of the memory subsystem cores via the scan dump path in the memory subsystem according to an embodiment.

FIG. 7 is a process flow diagram illustrating an example method for implementing configuration of the memory subsystem for implementing the scan dump of the memory subsystem cores via the scan dump path in the memory subsystem according to an embodiment.

FIG. 8 is a component block diagram illustrating an example mobile computing device suitable for implementing various embodiments.

FIG. 9 is a component block diagram illustrating an example mobile computing device suitable for implementing various embodiments.

FIG. 10 is a component block diagram illustrating an example server suitable for implementing various embodiments.

FIGS. 11A-11C are component block diagrams illustrating an example embedded vehicle computing system suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and computing devices implementing such methods of implementing a scan dump of memory subsystem cores. Embodiments may include enabling a scan dump path of the memory subsystem during a computing device crash reset flow. The scan dump path may include at least one memory controller having at least one scan dump logic module, a scan dump network on chip (NoC) module, and at least one scan dump data bus connecting the at least one scan dump logic module and the scan dump NoC. Some embodiments may include storing scan chain data for at least one core of the memory subsystem to a memory of the memory subsystem via the scan dump path of the memory subsystem during the computing device crash reset flow. Some embodiments may include reading the scan chain data of the at least one core of the memory subsystem out of the memory subsystem during the computing device crash reset flow, and writing the scan chain data for the at least one core of the memory subsystem to the memory of the memory subsystem via the scan dump path of the memory subsystem from out of the memory subsystem during the computing device crash reset flow.

The term “computing device” is used herein to refer to stationary computing devices including personal computers, desktop computers, all-in-one computers, workstations, super computers, mainframe computers, embedded computers (such as in vehicles and other larger systems), computing systems within or configured for use in vehicles, servers, multimedia computers, and game consoles. The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor.

Various embodiments are described in terms of code, e.g., processor-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

Complex computer chip design makes debugging issues resulting in a crash of a computing device complicated and time-consuming. For a computing device crash, debugging the issue can include dumping computer chip states to dynamic random access memory (DRAM) or on-chip memory during a computing device crash reset flow. Methods for dumping computer chip states include reading scan chains of computing device component cores and storing the scan chain data to the DRAM. Accessing the DRAM for storing the scan chain data to the DRAM requires that memory subsystem component cores be functional. As such, the memory subsystem component cores cannot be scan dumped during the computing device crash reset flow and issues with the memory subsystem component cores cannot be debugged using data gathered during the computing device crash reset flow.

Debugging issues with the memory subsystem component cores can be implemented using data from an engineer-prompted manual scan dump of the memory subsystem component cores outside of the computing device crash reset flow. However, this limited efficacy as the data for the memory subsystem component cores from the computing device crash incident are not retained and the conditions of the computing device crash incident must be reliably reproduced to extract relevant data from the memory subsystem component cores. Manual scan dumping of the memory subsystem component cores outside of the computing device crash reset flow adds financial cost, time, and effort to debugging issues resulting in a crash of a computing device.

Various embodiments address and overcome the foregoing issues relating to debugging issues resulting in a crash of a computing device using scan dump data of the memory subsystem component cores outside of the computing device crash reset flow. Various embodiments may include a scan dump path of a memory subsystem configured to enable scan dumping memory subsystem component cores, also referred to herein as memory subsystem cores, during a computing device crash reset flow. The scan dump path may enable storing scan chain data for the memory subsystem cores to a memory of the memory subsystem via the scan dump path during the computing device crash reset flow.

Various embodiments may provide further advantages, including enabling a scalable debugging solution while have a small impact on area usage of the memory subsystem. For example, some embodiments may include using existing cache, static random access memory (SRAM), of the memory subsystem to store scan chain data of the memory subsystem cores. As such, adding memory for storing the scan chain data for the memory subsystem cores may be avoided. Some embodiments may enable using the existing cache of the memory subsystem to store scan chain data of other computing device component cores via the scan dump path of the memory subsystem. The existing cache of the memory subsystem may be large enough to store scan chain data of the memory subsystem cores and at least one other computing device IP core. Existing means for debugging issues resulting in a crash of a computing device using scan dump data rely on memory integral to the component cores of the computing device.

Various embodiments may provide further advantages, including a security mechanism to delete secure content in the memory subsystem cache prior to enabling access to the memory subsystem cache for storing scan chain data of the memory subsystem cores and/or other computing device component cores. Deleting the secure content in the memory subsystem cache may prevent access to the secure content during a debugging process. Existing means for debugging issues resulting in a crash of a computing device using scan dump data do not account for security of secure content in the memory subsystem cache.

In some embodiments, the memory subsystem may include the scan dump path, having a scan dump NoC, at least one scan dump logic, a scan dump path bus connecting the scan dump NoC and the at least one scan dump logic, and selective connection components connecting the at least one scan dump logic and a memory subsystem cache. The scan dump NoC may be configured to receive scan chain and provide the scan chain data to the at least one scan dump logic via the scan dump path bus. In some embodiments, the scan chain data may be scan chain data for the memory subsystem cores. The scan dump NoC may receive the scan chain data for the memory subsystem cores from outside the memory subsystem via a memory subsystem NoC configured to receive the scan chain data from outside the memory subsystem and provide the scan chain data to the scan dump NoC. In some embodiments, the scan chain data may also be scan chain data for the other computing device component cores. In some embodiments, the scan dump NoC may similarly receive scan chain data for other computing device component cores from outside the memory subsystem via the memory subsystem NoC and provide the scan chain data to the scan dump NoC.

The at least one scan dump logic may be configured to store the scan chain data to the cache of the memory subsystem. In some embodiments, the at least one scan dump logic may write the scan chain data for the memory subsystem cores the cache of the memory subsystem. In some embodiments, the at least one scan dump logic may also write the scan chain data for the other computing device component cores the cache of the memory subsystem. Prior to store the scan chain data to the cache of the memory subsystem, the at least one scan dump logic may delete data, such as secure content, from the cache of the memory subsystem.

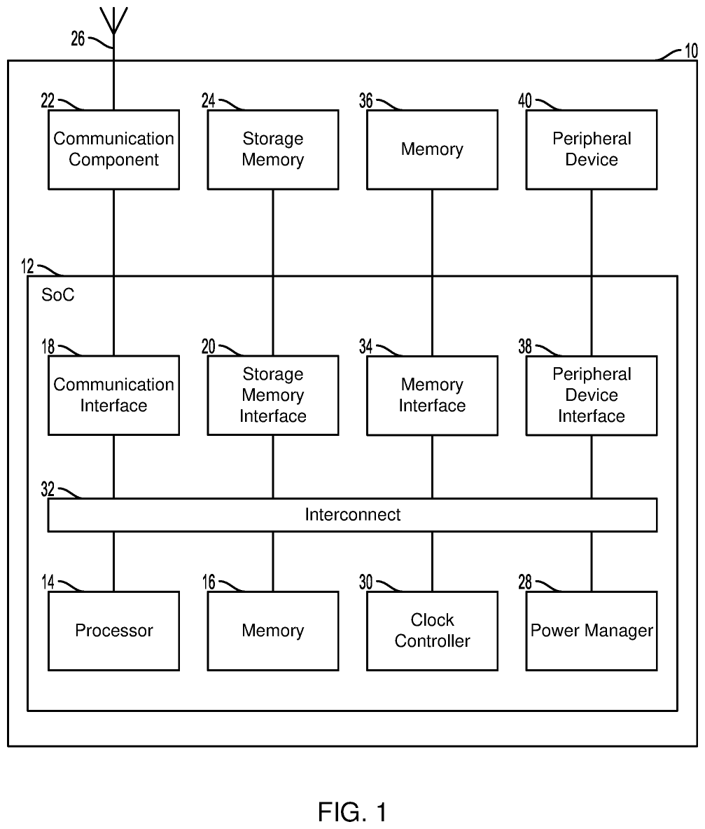

FIG. 1 illustrates a system including a computing device 10 suitable for use with various embodiments. With reference to FIG. 1, the computing device 10 may include a system-on-chip (SoC) 12 with a processor 14, a memory 16, a communication interface 18, a storage memory interface 20, a memory interface 34, a power manager 28, a clock controller 30, a peripheral device interface 38, and an interconnect 32. The computing device 10 may further include a communication component 22, such as a wired or wireless modem, a storage memory 24, an antenna 26 for establishing a wireless communication link, a memory 36, and a peripheral device 40. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), a secure processing unit (SPU), a subsystem processor of specific components of the computing device, such as an image processor for a camera subsystem or a display processor for a display, an auxiliary processor, a single-core processor, a multicore processor, a controller, and a microcontroller. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 14 that are not associated with an SoC 12. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16, 36 of the SoC 12 may be a volatile or non-volatile memory configured for storing data and processor-executable code for access by the processor 14. The computing device 10 and/or SoC 12 may include one or more memories 16, 36 configured for various purposes. One or more memories 16, 36 may include volatile memories such as random access memory (RAM) or main memory, including static RAM (SRAM) and/or dynamic RAM (DRAM), or cache memory. These memories 16, 36 may be configured to temporarily hold a limited amount of data received from a data sensor or subsystem, data and/or processor-executable code instructions that are requested from a non-volatile memory 16, 24, loaded to the memories 16 from the non-volatile memory 16, 24 in anticipation of future access based on a variety of factors, and/or intermediary processing data and/or processor-executable code instructions produced by the processor 14 and temporarily stored for future quick access without being stored in non-volatile memory 16, 24. The memory interface 34 and the memory 36 may work in unison to allow the computing device 10 to load and retrieve data and processor-executable code on the memory 36.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

The power manager 28 may be configured to control power states of one or more power rails (not shown) for power delivery to the components of the SoC 12. In some embodiments, the power manager 28 may be configured to control amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

A peripheral device interface 38 may enable components of the SoC 12, such as the processor 14 and/or the memory 16, to communicate with a peripheral device 40. The peripheral device interface 38 may provide and manage physical and logical connections between the components of the SoC 12 and the peripheral device 40. The peripheral device interface 38 may also manage communication between the components of the SoC 12 and the peripheral device 40, such as by directing and/or allowing communications between transmitter and receiver pairs of the components of the SoC 12 and the peripheral device 40 for a communication. The communications may include transmission of memory access commands, addresses, data, interrupt signals, state signals, etc. A peripheral device 40 may be any component of the computing device 10 separate from the SoC 12, such as a processor, a memory, a subsystem, etc. In some embodiments, the peripheral device interface 38 may include a PCIe root complex and may enable PCIe protocol communication between the components of the SoC 12 and the peripheral device 40.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling timing and/or transmission paths of the signals.

Some or all of the components of the computing device 10 and/or the SoC 12 may be arranged differently and/or combined while still serving the functions of the various embodiments. The computing device 10 may not be limited to one of each of the components, and multiple instances of each component may be included in various configurations of the computing device.

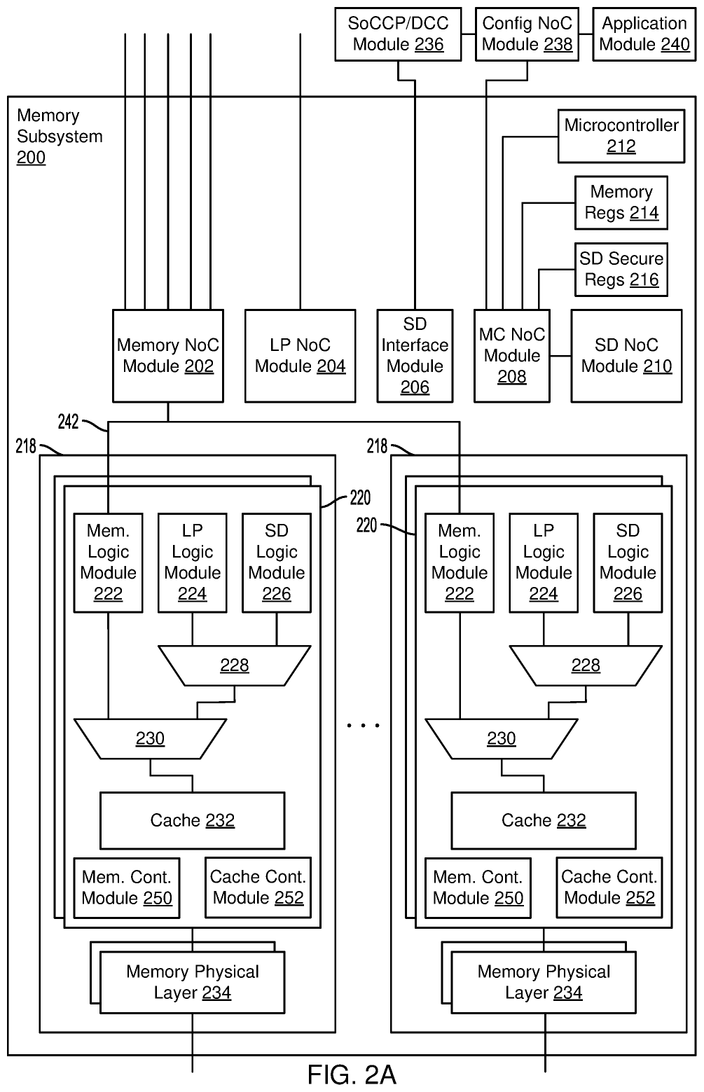

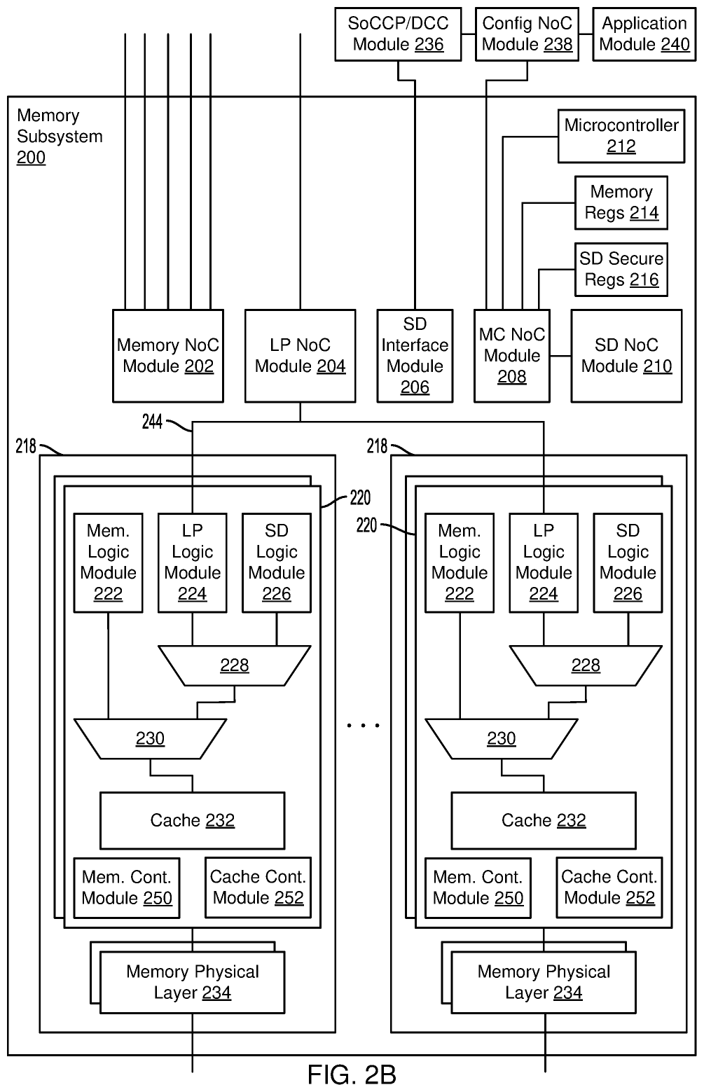

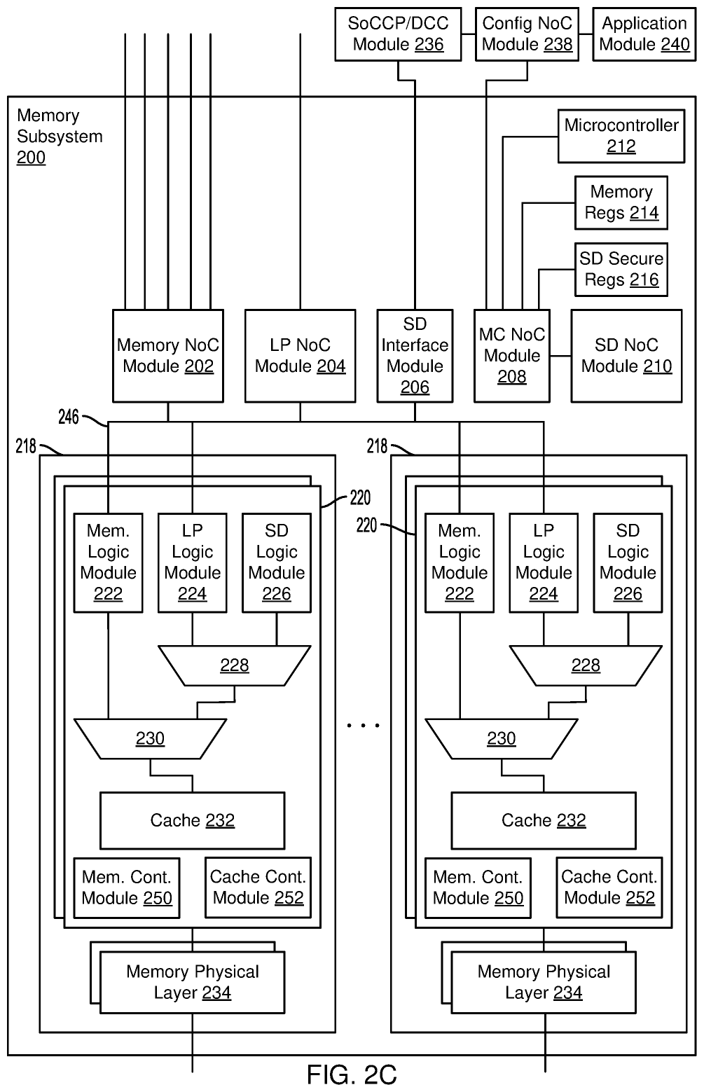

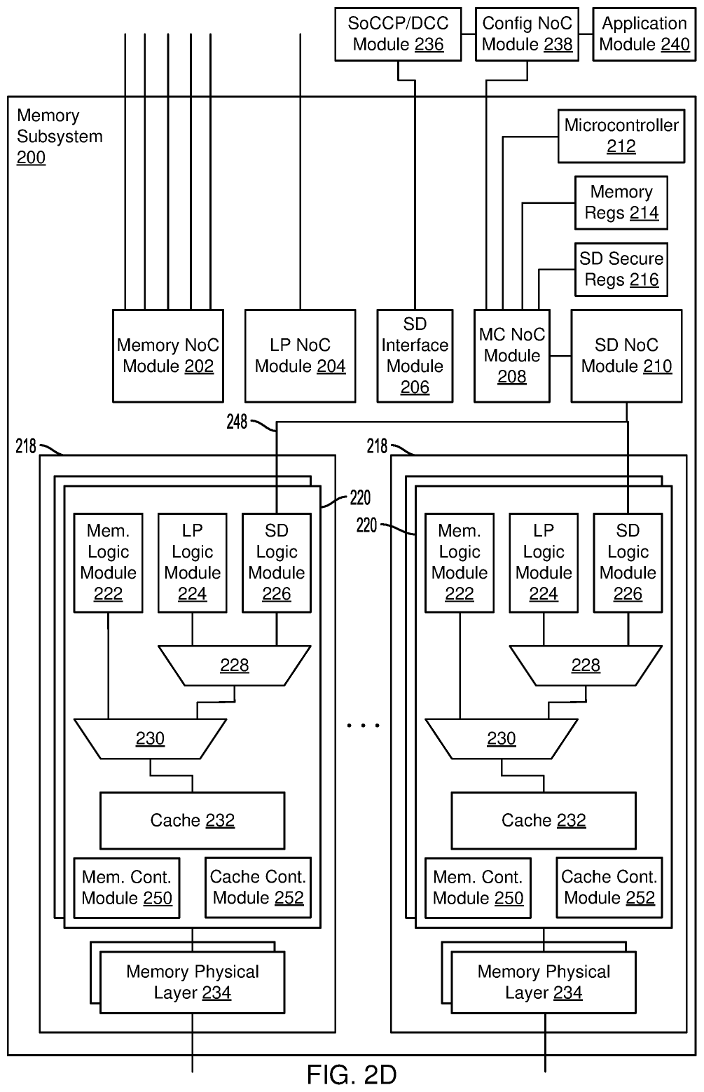

FIGS. 2A-2D illustrates an example memory subsystem 200 (e.g., memory interface 34, memory 36 in FIG. 1) of the computing device (e.g., computing device 10 in FIG. 1) suitable for implementing various embodiments. With reference to FIGS. 1-2D, the memory subsystem 200 may include components configured for enabling interaction between to a memory (e.g., memory 36 in FIG. 1) and components of an SoC (e.g., SoC 12 in FIG. 1) and/or a peripheral device (e.g., peripheral device 40 in FIG. 1) for reading from and writing to the memory. The memory may be configured as a random access memory (RAM) or main memory, such as a DRAM. The components of the SoC and/or the peripheral device are also referred to herein as computing device component cores, and may include one or more of a processing core (e.g., processor 14 in FIG. 1), a memory core (e.g., memory 16 in FIG. 1), a networking, network on chip (NoC), core (e.g., communication interface 18, storage memory interface 20, interconnect 32 peripheral device interface 38 in FIG. 1), etc. FIGS. 2A-2D illustrate different aspects of the same memory subsystem 200, including a memory path bus 242 in FIG. 2A, a low power memory path bus 244 in FIG. 2B. a scan path bus 246 in FIG. 2C, and a scan dump path bus 248 in FIG. 2D, as described further herein.

The memory subsystem 200 may include at least one memory channel 218, such as one, two, four, eight, etc. channels. Each memory channel 218 may include at least one memory and cache controller 220 and at least one memory physical layer 234. Each memory and cache controller 220 may be configured to control access to and implement operations at a cache 232 of the cache memory and controller 220 and/or for the memory channel 218 at the memory via an associated memory physical layer 234. For example, the memory and cache controller 220 may include a memory (mem.) controller (cont.) module 242 configured to control access to and implement operations at the memory. As a further example, the memory and cache controller 220 may include a cache controller (cont.) module 244 configured to control access to and implement operations at a cache 232 of the cache memory and controller 220. In some embodiments, the cache 232 may be a system level cache, or system cache, (also known as last level cache) that may be a shared on-chip cache resource that various computing device cores (e.g., processor 14, communication component 22, peripheral device 40 in FIG. 1) may share. The system level cache may also be a last level cache on the SoC.

The cache memory and controller 220 may include a memory (mem.) logic module 222, a low power (LP) logic module 224, and a scan dump (SD) logic module 226 that may be connected to the cache 232 for controlling access to and implementing operations at the cache 232. The memory logic module 222, the low power logic module 224, and the scan dump logic module 226 may be connected to the cache via one or more selective connection components, such as multiplexers 228, 230. The selective connection components 228, 230 may be configured for selecting which of the memory logic module 222, the low power logic module 224, and the scan dump logic module 226 to connect to the cache 232 to control access to and implement operations at the cache 232.

The memory logic module 222 may be configured to control access to and implement operations at the cache 232 during normal operation of the computing device and/or the memory subsystem 200. For example, normal operation may include active use of the computing device by a user. During normal operation, one or more of the selective connection components 228, 230 may connect the memory logic module 222 to the cache 232.

The memory subsystem 200 may include a memory NoC module 202 configured to transmit commands and data between at least one memory logic module 222 and computing device component cores (not shown) outside of the memory subsystem 200 during normal operation of the computing device and/or the memory subsystem 200. The memory NoC module 202 may be connected to the at least one memory logic module 222 via the memory path bus 242, as illustrated in the example shown in FIG. 2A.

The low power logic module 224 may be configured to control access to and implement operations at the cache 232 during low power operation of the computing device and/or the memory subsystem 200. For example, low power operation may include the computing device operating in a standby state, such as when the computing device processes notifications using the memory subsystem 200 while a screen of the computing device is off. During low power operation, one or more of the selective connection components 228, 230 may connect the low power logic module 224 to the cache 232.

The memory subsystem 200 may include a low power (LP) NoC module 204 configured to transmit commands and data between at least one low power logic module 224 and computing device component cores (not shown) outside of the memory subsystem 200 during low power operation of the computing device and/or the memory subsystem 200. The low power NoC module 204 may be connected to the at least one low power logic module 224 via the low power memory path bus 244, as illustrated in the example shown in FIG. 2B.

The scan dump logic module 226 may be configured to control access to and implement operations at the cache 232 during crash operation of the computing device and/or the memory subsystem 200. For example, crash operation may include the computing device implementing a crash reset flow to recover from a crash of the computing device. During crash operation, one or more of the selective connection components 228, 230 may connect the scan dump logic module 226 to the cache 232.

The memory subsystem 200 may include a scan dump (SD) interface module 206 and a scan dump (SD) NoC module 208 configured to transmit commands and data between at least one scan dump logic module 226 and memory subsystem cores of the memory subsystem 200 during crash operation of the computing device and/or the memory subsystem 200. The memory subsystem cores may include, one or more of the memory NoC module 202, the low power NoC module 204, the memory logic modules 222, the low power logic modules 224, the caches 232, the memory controller module 242, cache the controller module 244, etc. The scan dump interface module 206 may be connected to the memory subsystem cores via the scan path bus 246, as illustrated in the example shown in FIG. 2C. The scan dump NoC module 208 may be connected to the at least one scan dump logic module 226 via the scan dump path bus 248, as illustrated in the example shown in FIG. 2D.

The memory subsystem 200 may also include a microcontroller 212 configured to trigger a scan dump of the memory subsystem cores. The microcontroller 212 identify a condition for triggering the scan dump of the memory subsystem cores. For example, the condition may include a signal configured to indicate a computing device crash and one or more of a register value configured to indicate to trigger the scan dump of the memory subsystem cores and/or timeout and/or error indicators for one or more memory subsystem 200 components, such as the memory NoC module 202, the cache 232, and/or memory controller (not shown). The register value configured to indicate to trigger the scan dump of the memory subsystem cores may be read from memory registers 214, which may include at scan dump (SD) secure registers 216. The scan dump secure registers 216 may include settings for the microcontroller 212 for identifying the condition for triggering the scan dump of the memory subsystem cores. The condition for triggering the scan dump of the memory subsystem cores may be a condition of the computing device executing a crash reset flow to recover from a computing device crash and triggering the scan dump of the memory subsystem cores may cause implementation of the scan dump of the memory subsystem cores during the crash reset flow.

In response to identifying the condition for triggering the scan dump of the memory subsystem cores, the microcontroller 212 may trigger the scan dump logic modules 226 to enable the scan dump path, having the scan dump NoC module 210, the at least one scan dump logic module 226, the scan dump path bus 248, and the selective connection components 228, 230. Enabling the scan dump path may include enabling a clock for the scan dump path, enabling the selective connection components 228, 230 connecting the at least one scan dump logic module 226 to the associated cache 232, clearing the associated cache 232, enabling the scan dump NoC module 210, and/or signaling that the scan dump path is ready, such as by setting a status bit register at the memory registers 214, which may include at the scan dump secure registers 216. In some embodiments, the scan dump path may be powered by a power rail different from the memory subsystem cores. In some embodiments, the scan dump path may communicate via advanced microcontroller bus architecture high-performance bus (AHB) protocol.

Scan chain data may be read out from the memory subsystem cores to the scan dump interface module 206 via the scan path bus 246. The scan chain data may include flip flop values and/or cached values at the memory subsystem cores. From the scan dump interface module 206, the scan chain data of the memory subsystem cores may be transmitted out of the memory subsystem 200 to an SoC control plane (SoCCP) and/or data capture and compare engine (DCC) module 236, to a configuration (Config) NoC module 238, and back into the memory subsystem 200 to a memory configuration (MC) NoC module 208. For example, the SoC control plane module 236 may implement software to enable transmitting the scan chain data of the memory subsystem cores out of and back into the memory subsystem 200. For example, the data capture and compare engine module 236 may implement hardware to enable transmitting the scan chain data of the memory subsystem cores out of and back into the memory subsystem 200. In some embodiments, transmission out of and into the memory subsystem 200 with the SoC control plane and/or data capture and compare engine module 236 and the configuration NoC module 238 may be via AHB protocol. The scan chain data of the memory subsystem cores may be transmitted from the memory configuration NoC module 208 to the scan dump NoC module 210, and from the scan dump NoC module 210 to the at least one scan dump logic module 226 via the scan dump path bus 248. The at least one scan dump logic module 226 may write the scan chain data of the memory subsystem cores to the connected cache 232 via the selective connection components 228, 230. Scan chain data stored to the connected cache 232 may be referred to as scan dump data.

In some embodiments, the scan dump NoC module 208 may be configured to transmit commands and data between at least one scan dump logic module 226 and computing device component cores, including one or more of a processing core, a memory core, a networking core, etc., such as an application module 240, outside of the memory subsystem 200 during crash operation of the computing device. Scan chain data from the computing device component cores may be transmitted to the configuration NoC module 238, and into the memory subsystem 200 to the memory configuration NoC module 208. In some embodiments, transmission into the memory subsystem 200 with the configuration NoC module 238 may be via AHB protocol. The scan chain data of the computing device component cores may be transmitted from the memory configuration NoC module 208 to the scan dump NoC module 210, and from the scan dump NoC module 210 to the at least one scan dump logic module 226 via the scan dump path bus 248. The at least one scan dump logic module 226 may write the scan chain data of the computing device component cores to the connected cache 232 via the selective connection components 228, 230.

In some embodiments, the cache 232 may be configured in a non-cacheable mode. A bootloader executed as part of the crash reset flow, such as by the application module 240, may configure direct memory access to the cache 232 to read the scan dump data stored to the cache 232 and write the scan dump data to a file. The scan dump data of the file may be used to debug issues resulting in the crash of the computing device, including issues of the memory subsystem cores.

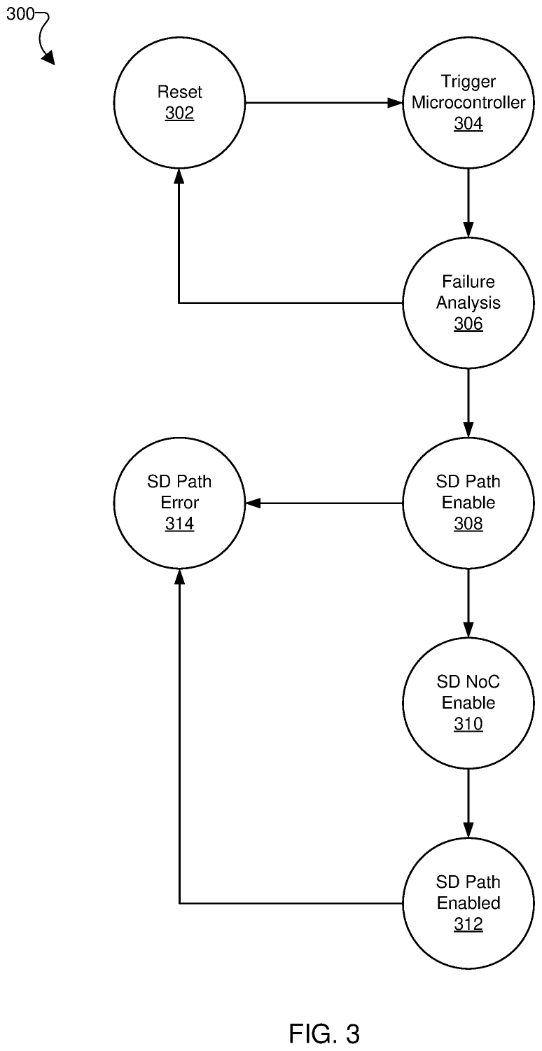

FIG. 3 illustrates an example of a state machine process 300 for implementing a scan dump path in the memory subsystem (e.g., memory subsystem 200 in FIGS. 2A-2D) suitable for implementing various embodiments. With reference to FIGS. 1-3, the state machine process 300 may be implemented at the memory subsystem, such as by the microcontroller (e.g., microcontroller 212 in FIGS. 2A-2D).

The microcontroller may rest in a reset state 302, during which the scan dump path, configured for scan dumping the memory subsystem cores, may be disabled. For example, the scan dump path being disabled may include at least one of the scan dump NoC module (e.g., scan dump NoC module 210 in FIGS. 2A-2D), the scan dump logic module (e.g., scan dump logic module 226 in FIGS. 2A-2D), the scan dump path bus (e.g., scan dump path bus 248 in FIG. 2D), and the selective connection component (e.g., selective connection component 228 in FIGS. 2A-2D) being disabled.

From the reset state 302, the microcontroller may transition to a trigger microcontroller state 304 in response to receiving the signal configured to indicate a computing device crash. The trigger microcontroller state 304 may prompt the microcontroller to begin the process for scan dumping the memory subsystem cores.

From the trigger microcontroller state 304, the microcontroller may transition to a failure analysis state 306, in which the microcontroller may identify a condition for triggering the scan dump of the memory subsystem cores. For example, the condition may include one or more of a register values configured to indicate to trigger the scan dump of the memory subsystem cores and/or timeout and/or error indicators for one or more memory subsystem 200 components, such as a memory NoC module (e.g., memory NoC module 202 in FIG. 2), cache (e.g., cache 232 in FIG. 2), and/or memory controller. The one or more register values may be set, for example, at the microcontroller and/or at the memory registers (e.g., memory registers 214 in FIGS. 2A-2D), which may include at the scan dump secure registers (e.g., scan dump secure registers 216 in FIGS. 2A-2D). In response to failing to identify a condition for triggering the scan dump of the memory subsystem cores during the failure analysis state 306, the microcontroller may transition to the reset state 302, without triggering the scan dump of the memory subsystem cores.

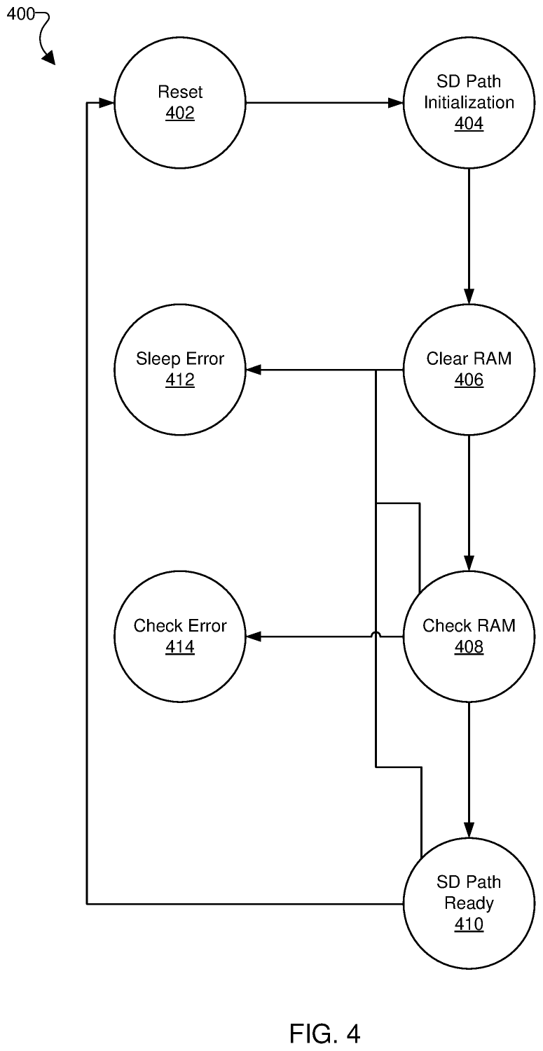

In response to identifying a condition for triggering the scan dump of the memory subsystem cores during the failure analysis state 306, the microcontroller may transition to a scan dump (SD) path enable state 308. During the scan dump path enable state 308, the microcontroller may trigger the scan dump logic module (e.g., scan dump logic module 226 in FIGS. 2A-2D) to enable components of the scan dump path, as described herein for a state machine process 400 with reference to FIG. 4. The microcontroller may trigger the scan dump logic module to enable components of the scan dump path by, for example, setting a register value, such as at the microcontroller, at the scan dump logic module, and/or at the memory registers, which may include at the scan dump secure registers. Upon failure of the scan dump path enable state 308, the microcontroller may transition to a scan dump (SD) path error state 314. In some embodiments, failure of the scan dump path enable state 308 may include failure of the state machine process 400 and/or failure to complete the state machine process 400 within a threshold execution period. For example, failure of the scan dump path enable state 308 may include occurrence of an error during the state machine process 400.

Upon completion of the scan dump path enable state 308, the microcontroller may transition to a scan dump (SD) NoC enable state 310. In some embodiments, completion of the scan dump path enable state 308 may include completion of the state machine process 400 and/or completion of the state machine process 400 within the threshold execution period. During the scan dump NoC enable state 310, the microcontroller may enable the scan dump NoC module (e.g., scan dump NoC module 210 in FIGS. 2A-2D). Enabling the scan dump NoC module may include setting a register value, such as at a register of the scan dump NoC module and/or the memory registers, which may include at the scan dump secure registers, configured to enable use and operation of the scan dump NoC module.

From the scan dump NoC enable state 310, the microcontroller may transition to a scan dump (SD) path enabled state 312. During the scan dump path enabled state 312, the microcontroller may set and/or maintain a scan dump path enabled indicator configured to indicate that the scan dump path is enabled to implement a scan dump of memory subsystem cores. For example, the scan dump path ready indicator may be a register value set at the microcontroller and/or at the memory registers, which may include at the scan dump secure registers. In some embodiments, the scan dump path enabled indicator may be configured to indicate that the scan dump path is enabled to implement a scan dump of computing device component cores as well. During the scan dump path enabled state 312, in response to occurrence of an error during the state machine process 400, the microcontroller may transition to the scan dump path error state 314.

FIG. 4 illustrates an example of a state machine process 400 for implementing a scan dump path in the memory subsystem (e.g., memory subsystem 200 in FIGS. 2A-2D) suitable for implementing various embodiments. With reference to FIGS. 1-4, the state machine process 400 may be implemented at the memory subsystem, such as by the scan dump logic module (e.g., scan dump logic module 226 in FIGS. 2A-2D).

The scan dump logic module may rest in a reset state 402, during which the scan dump path, configured for scan dumping the memory subsystem cores, may be disabled. For example, the scan dump path being disabled may include at least one of the scan dump NoC module (e.g., scan dump NoC module 210 in FIGS. 2A-2D), the scan dump logic module (e.g., scan dump logic module 226 in FIGS. 2A-2D), the scan dump path bus (e.g., scan dump path bus 248 in FIG. 2D), and the selective connection component (e.g., selective connection component 228 in FIGS. 2A-2D) being disabled.

From the reset state 402, the scan dump logic module may transition to a scan dump (SD) path initialization state 404 in response to a trigger to enable components of the scan dump path from the microcontroller (e.g., microcontroller 212 in FIGS. 2A-2D). For example, the trigger may be the register value set during the scan dump path enable state (e.g., scan dump path enable state 308 in FIG. 3) for the microcontroller. The trigger to enable components of the scan dump path may prompt the scan dump logic module to begin the process for enabling components of the scan dump path. For example, during the scan dump path initialization state 404, the scan dump logic module may enable at least one selective connection component of the scan dump path. Enabling the at least one selective connection component may include setting a register value configured to indicate that the at least one selective connection component is enabled. For example, the register value may be set at the at the memory registers (e.g., memory registers 214 in FIGS. 2A-2D), which may include at the scan dump secure registers (e.g., scan dump secure registers 216 in FIGS. 2A-2D).

From the scan dump path initialization state 404, the scan dump logic module may transition to a clear RAM state 406, during which the scan dump logic module may clear the caches (e.g., caches 232 in FIGS. 2A-2D) of the memory subsystem. For example, the scan dump logic module may clear the caches by overwriting data, including secure content, stored at the caches. The scan dump logic module may overwrite data stored at the caches with a constant value, a pattern of values, and/or random values, where any such values may include “0” and/or “1.”

During and/or following the clear RAM state 406, the scan dump logic module may implement a sleep error state 412. The sleep error state 412 may be triggered by a failure of the clear RAM state 406 resulting from one or more of the caches of the memory subsystem being in a sleep state (e.g., retention sleep and/or non-retention sleep), preventing the scan dump logic module from clearing the one or more caches. At the sleep error state 412, the scan dump logic module may set a sleep error register value configured to indicate a sleep error resulting from failure of the clear RAM state 406. For example, the register value may be set at the memory registers, which may include at the scan dump secure registers. In some embodiments, the sleep error may indicate to the microcontroller failure of the state machine process 400, such as at the scan dump path enable state and/or the scan dump path ready state (e.g., scan dump path ready state 312 in FIG. 3).

From successful implementation of the clear RAM state 406, the scan dump logic module may transition to a check RAM state 408, during which the scan dump logic module may check whether the caches of the memory subsystem have been cleared. For example, the scan dump logic module may check for expected values at the caches resulting from clearing the caches during the RAM state 406.

In response to failure of the check RAM state 408, the scan dump logic module may implement the sleep error state 412 and/or a check error state 414. The sleep error state 412 may be triggered by a failure of the check RAM state 408 resulting from one or more of the caches of the memory subsystem being in a sleep state, preventing the scan dump logic module from checking the one or more caches. At the sleep error state 412, the scan dump logic module may set the sleep error register value configured to indicate the sleep error resulting from failure of the check RAM state 408. Failure of the check RAM state 408 may result from identifying an unexpected value at the caches. At the check error state 414, the scan dump logic module may set a check error register value configured to indicate a check error resulting from failure of the check RAM state 408. For example, the register value may be set at the memory registers, which may include at the scan dump secure registers. In some embodiments, the check error may indicate to the microcontroller failure of the state machine process 400, such as at the scan dump path enable state and/or the scan dump path ready state.

From successful implementation of the check RAM state 408, the scan dump logic module may transition to a scan dump (SD) path ready state 410. During the scan dump path ready state 410, the scan dump logic module may set and/or maintain a scan dump path ready indicator. The scan dump path ready indicator may be configured to indicate that portions of the scan dump path, including the at least one selective connection component and the caches, are ready for the scan dump path to be enabled to implement a scan dump of memory subsystem cores. For example, the scan dump path ready indicator may be a register value set at the memory registers, which may include at the scan dump secure registers. In some embodiments, the scan dump path ready indicator may be configured to indicate that the portions of the scan dump path are ready to implement a scan dump of computing device component cores as well. In some embodiments, the scan dump logic module may maintain the scan dump path ready indicator as long as the trigger to enable components of the scan dump path is set. Otherwise, from the scan dump path ready state 410, the scan dump logic module may transition to the ready state 402.

In response to failure of the scan dump path ready state 410, the scan dump logic module may implement the sleep error state 412. The sleep error state 412 may be triggered by a failure of the scan dump path ready state 410 resulting from one or more of the caches of the memory subsystem being in a sleep state, preventing the scan dump logic module from setting and/or maintaining the scan dump path ready indicator. At the sleep error state 412, the scan dump logic module may set the sleep error register value configured to indicate the sleep error resulting from failure of the scan dump path ready state 410.

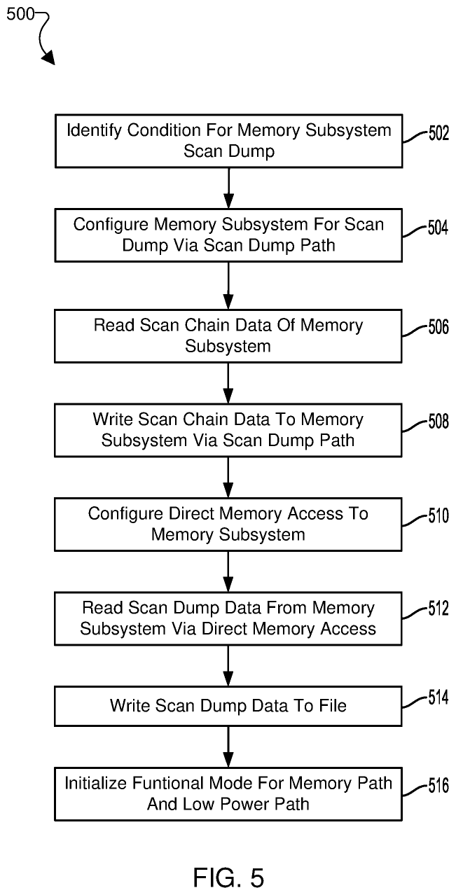

FIG. 5 illustrates an example method 500 for implementing a scan dump of memory subsystem cores via the scan dump path in the memory subsystem (e.g., memory subsystem 200 in FIGS. 2A-2D) according to various embodiments. With reference to FIGS. 1-5, the method 500 may be implemented in a computing device (e.g., computing device 10 in FIG. 1, memory subsystem 200 in FIGS. 2A-2D), in hardware (e.g., memory interface 34 in FIG. 1, microcontroller 212, scan dump logic module 226 in FIGS. 2A-2D), in software (e.g., scan dump logic module 226 in FIGS. 2A-2D) executing in a processor (e.g., memory and cache controller 220 in FIGS. 2A-2D), or in a combination of a software-configured processor and dedicated hardware, such as the memory subsystem (e.g., memory subsystem 200 in FIGS. 2A-2D), that includes other individual components, such as various memories/caches (e.g., caches 232 in FIGS. 2A-2D) and various memory/cache controllers (e.g., memory and cache controller 220 in FIGS. 2A-2D). In order to encompass the alternative configurations enabled in various embodiments, the hardware implementing the method 500 is referred to herein as a “memory subsystem scan dump device.”

In block 502, the memory subsystem scan dump device may identify a condition for a memory subsystem scan dump. The memory subsystem scan dump device may be configured to trigger a scan dump of the memory subsystem cores in response to identifying the condition. For example, the condition may include a signal configured to indicate a computing device crash and one or more of a register value configured to indicate to trigger the scan dump of the memory subsystem cores and/or timeout and/or error indicators for one or more memory subsystem components, such as a memory NoC module (e.g., memory NoC module 202 in FIG. 2), cache (e.g., cache 232 in FIG. 2), and/or memory controller. The one or more register values may be set, for example, at the memory subsystem scan dump device and/or at the memory registers (e.g., memory registers 214 in FIGS. 2A-2D), which may include at the scan dump secure registers (e.g., scan dump secure registers 216 in FIGS. 2A-2D). In some embodiments, the memory subsystem scan dump device identifying the condition for a memory subsystem scan dump in block 502 may be the microcontroller (e.g., microcontroller 212 in FIGS. 2A-2D).

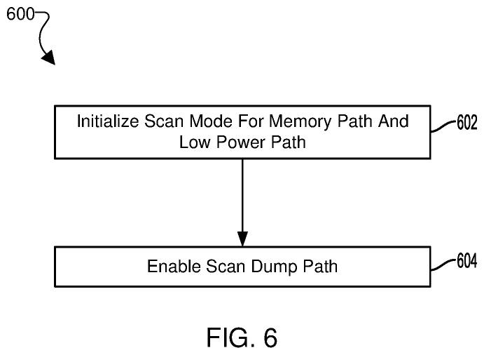

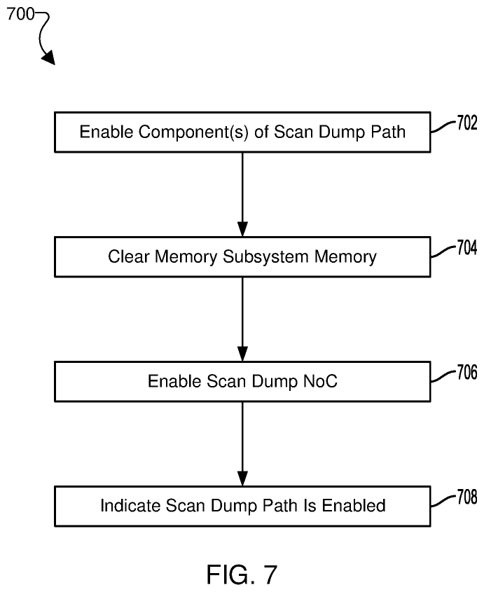

In block 504, the memory subsystem scan dump device may configure the memory subsystem for a scan dump via the scan dump path. The memory subsystem scan dump device may receive a trigger to configure the memory subsystem. The trigger may be received in response to identifying the condition for a memory subsystem scan dump. Configuring the memory subsystem for a scan dump via the scan dump path may include enabling components of the scan dump path as described herein for the methods 600 and 700 with reference to FIGS. 6 and 7. Enabling components of the scan path may include enabling at least one of the scan dump NoC module (e.g., scan dump NoC module 210 in FIGS. 2A-2D), the at least one scan dump logic module (e.g., scan dump logic module 226 in FIGS. 2A-2D), the scan dump path bus (e.g., scan dump path bus 248 in FIG. 2D), and the selective connection components (e.g., selective connection components 228, 230 in FIGS. 2A-2D). In some embodiments, the memory subsystem scan dump device configuring the memory subsystem for a scan dump via the scan dump path in block 504 may be the microcontroller, the scan dump logic module (e.g., scan dump logic module 226 in FIGS. 2A-2D), and/or the memory and cache controller (e.g., memory and cache controller 220 in FIGS. 2A-2D).

In block 506, the memory subsystem scan dump device may read scan chain data out of the memory subsystem. The memory subsystem scan dump device may read scan chain data from one or more memory subsystem cores. The memory subsystem cores may include: one or more of the memory NoC module (e.g., memory NoC module 202 in FIGS. 2A-2D); the low power NoC module (e.g., low power NoC module 204 in FIGS. 2A-2D); the memory logic modules (e.g., memory logic modules 222 in FIGS. 2A-2D); the low power logic modules (e.g., low power logic modules 224 in FIGS. 2A-2D); the caches (e.g., caches 232 in FIGS. 2A-2D); the memory controller modules (e.g., memory controller modules 242 in FIGS. 2A-2D), the cache the controller modules (e.g., cache the controller modules 244 in FIGS. 2A-2D); etc. The scan chain data may include flip flop values and/or cached values at the memory subsystem cores. The memory subsystem scan dump device may receive the scan chain data via the scan path bus (e.g., scan path bus 246 in FIG. 2C) connecting the memory subsystem scan dump device to the one or more memory subsystem cores, and transmit the scan chain data out of the memory subsystem to an SoC control plane and/or data capture and compare engine module (e.g., SoC control plane and/or data capture and compare engine module 236 in FIGS. 2A-2D). In some embodiments, the memory subsystem scan dump device reading the scan chain data out of the memory subsystem in block 506 may be the microcontroller and/or the scan dump interface module (e.g., scan dump interface module 206 in FIGS. 2A-2D).

In block 508, the memory subsystem scan dump device may write the scan chain data to the memory subsystem via the scan dump path. The scan chain data read out of the memory subsystem to the SoC control plane and/or data capture and compare engine module may be transmitted to the configuration NoC module (e.g., configuration NoC module 238 in FIGS. 2A-2D). The configuration NoC module may transmit the scan chain data back into the memory subsystem to the memory configuration NoC module (e.g., memory configuration NoC module 208 in FIGS. 2A-2D). The scan chain data may be passed from the memory configuration NoC module to the scan dump path at the scan dump NoC module. The scan chain data may propagate through the scan dump path, from the scan dump NoC module to the at least one scan dump logic module via the scan dump path bus. The scan dump logic module may write the scan chain data to the cache via the selective connection components. The scan chain data stored to the cache may be referred to as scan dump data. In some embodiments, the memory subsystem scan dump device writing the scan chain data to the memory subsystem via the scan dump path in block 508 may be the microcontroller, the memory configuration NoC module, the scan dump NoC module, the scan dump logic module, and/or the memory and cache controller.

In block 510, the memory subsystem scan dump device may configure direct memory access to the memory subsystem. The memory subsystem scan dump device may execute a boot loader that may configure direct memory access to the cache at which the scan dump data is stored. In some embodiments, the memory subsystem scan dump device configuring direct memory access to the memory subsystem in block 510 may be the microcontroller, the memory configuration NoC module, the scan dump NoC module, the scan dump logic module, the memory and cache controller, and/or the application module (e.g., application module 240 in FIGS. 2A-2D).

In block 512, the memory subsystem scan dump device may read the scan dump data from the memory subsystem via the direct memory access. The memory subsystem scan dump device may access the cache via direct memory access and read the scan dump data stored at the cache. In some embodiments, the memory subsystem scan dump device reading the scan dump data from the memory subsystem via the direct memory access in block 512 may be the microcontroller, the memory configuration NoC module, the scan dump NoC module, the scan dump logic module, the memory and cache controller, and/or the application module.

In block 514, the memory subsystem scan dump device may write the scan dump data to a file. The scan dump data read from the cache may be written to a file that may be configured for use in debugging issues causing the crash of the computing device, including debugging issues in the memory subsystem cores. In some embodiments, the memory subsystem scan dump device writing the scan dump data to the file in block 514 may be the microcontroller, the memory configuration NoC module, the scan dump NoC module, the scan dump logic module, the memory and cache controller, and/or the application module.

In block 516, the memory subsystem scan dump device may initialize a functional mode for a memory path and a low power memory path of the memory subsystem. The memory path may include the memory NoC module (e.g., memory NoC module 202 in FIGS. 2A-2D), the at least one memory logic module (e.g., memory logic module 222 in FIGS. 2A-2D), and the memory path bus (e.g., memory path bus 242 in FIG. 2A). The low power memory path may include the low power NoC module (e.g., low power NoC module 204 in FIGS. 2A-2D), the at least one low power logic module (e.g., low power logic module 224 in FIGS. 2A-2D), and the low power memory path bus (e.g., low power memory path bus 244 in FIG. 2B).

Initializing the functional mode for the memory path and the low power memory path may include setting one or more register values configured to indicate that the functional mode is initialized. The one or more register values may be set, for example, at the memory registers (e.g., memory registers 214 in FIGS. 2A-2D), which may include at the scan dump secure registers (e.g., scan dump secure registers 216 in FIGS. 2A-2D). The functional mode may enable use of the memory path and the low power memory path while initialized, which may enable access to the cache of the memory subsystem. For example, the functional mode may include enabling access to, clock signals to, and/or power to one or more components of the memory path and the low power memory path, including one or more of the memory subsystem cores. During and/or following initializing the functional mode for the memory path and the low power memory path, the memory subsystem, including the cache, may retain the scan dump data. In some embodiments, the memory subsystem scan dump device initializing the functional mode for the memory path and the low power memory path of the memory subsystem in block 516 may be the microcontroller and/or the memory and cache controller.

In some embodiments any combination of blocks 502-516 may be implemented by the memory subsystem scan dump device following a cash of the computing device and during a crash reset flow for the computing device to recover from the crash.

FIG. 6 illustrates an example method 600 for implementing configuration of the memory subsystem (e.g., memory subsystem 200 in FIGS. 2A-2D) for implementing the scan dump of the memory subsystem cores via the scan dump path in the memory subsystem according to various embodiments. With reference to FIGS. 1-6, the method 600 may be implemented in a computing device (e.g., computing device 10 in FIG. 1, memory subsystem 200 in FIGS. 2A-2D), in hardware (e.g., memory interface 34 in FIG. 1, microcontroller 212, scan dump logic module 226 in FIGS. 2A-2D), in software (e.g., scan dump logic module 226 in FIGS. 2A-2D) executing in a processor (e.g., memory and cache controller 220 in FIGS. 2A-2D), or in a combination of a software-configured processor and dedicated hardware, such as the memory subsystem (e.g., memory subsystem 200 in FIGS. 2A-2D), that includes other individual components, such as various memories/caches (e.g., caches 232 in FIGS. 2A-2D) and various memory/cache controllers (e.g., memory and cache controller 220 in FIGS. 2A-2D). In order to encompass the alternative configurations enabled in various embodiments, the hardware implementing the method 600 is referred to herein as a “memory subsystem scan dump device.”

In block 602, the memory subsystem scan dump device may initialize a scan mode for a memory path and a low power memory path of the memory subsystem. The memory path may include the memory NoC module (e.g., memory NoC module 202 in FIGS. 2A-2D), the at least one memory logic module (e.g., memory logic module 222 in FIGS. 2A-2D), and the memory path bus (e.g., memory path bus 242 in FIG. 2A). The low power memory path may include the low power NoC module (e.g., low power NoC module 204 in FIGS. 2A-2D), the at least one low power logic module (e.g., low power logic module 224 in FIGS. 2A-2D), and the low power memory path bus (e.g., low power memory path bus 244 in FIG. 2B).

Initializing the scan mode for the memory path and the low power memory path may include setting one or more register values configured to indicate that the scan mode is initialized. The one or more register values may be set, for example, at the memory registers (e.g., memory registers 214 in FIGS. 2A-2D), which may include at the scan dump secure registers (e.g., scan dump secure registers 216 in FIGS. 2A-2D). The scan mode may prevent use of the memory path and the low power memory path while initialized, which may prevent access to a cache (e.g., cache 232 in FIGS. 2A-2D) of the memory subsystem. For example, the scan mode may include restricting access to, clock gating, and/or power collapsing one or more components of the memory path and the low power memory path. In some embodiments, the memory subsystem scan dump device initializing the scan mode for the memory path and the low power memory path of the memory subsystem in block 602 may be the microcontroller (e.g., microcontroller 212 in FIGS. 2A-2D) and/or the memory and cache controller (e.g., memory and cache controller 220 in FIGS. 2A-2D).

In block 604, the memory subsystem scan dump device may enable the scan dump path of the memory subsystem. The memory subsystem scan dump device may receive a trigger to enable the scan dump path. The trigger may be received in response to identifying the condition for a memory subsystem scan dump described for block 502 of the method 500 with reference to FIG. 5. Enabling the scan dump path may include enabling components of the scan dump path as described herein for the method 700 with reference to FIG. 7. Enabling components of the scan path may include enabling at least one of the scan dump NoC module (e.g., scan dump NoC module 210 in FIGS. 2A-2D), the at least one scan dump logic module (e.g., scan dump logic module 226 in FIGS. 2A-2D), the scan dump path bus (e.g., scan dump path bus 248 in FIG. 2D), and the selective connection components (e.g., selective connection components 228, 230 in FIGS. 2A-2D). In some embodiments, the memory subsystem scan dump device enabling the scan dump path of the memory subsystem in block 604 may be the microcontroller, the scan dump logic module (e.g., scan dump logic module 226 in FIGS. 2A-2D), and/or the memory and cache controller.

In some embodiments any combination of blocks 602 and 604 may be implemented by the memory subsystem scan dump device following a cash of the computing device and during a crash reset flow for the computing device to recover from the crash.

FIG. 7 illustrates an example method 700 for implementing configuration of the memory subsystem (e.g., memory subsystem 200 in FIGS. 2A-2D) for implementing the scan dump of the memory subsystem cores via the scan dump path in the memory subsystem according to various embodiments. With reference to FIGS. 1-7, the method 700 may be implemented in a computing device (e.g., computing device 10 in FIG. 1, memory subsystem 200 in FIGS. 2A-2D), in hardware (e.g., memory interface 34 in FIG. 1, microcontroller 212, scan dump logic module 226 in FIGS. 2A-2D), in software (e.g., scan dump logic module 226 in FIGS. 2A-2D) executing in a processor (e.g., memory and cache controller 220 in FIGS. 2A-2D), or in a combination of a software-configured processor and dedicated hardware, such as the memory subsystem (e.g., memory subsystem 200 in FIGS. 2A-2D), that includes other individual components, such as various memories/caches (e.g., caches 232 in FIGS. 2A-2D) and various memory/cache controllers (e.g., memory and cache controller 220 in FIGS. 2A-2D). In order to encompass the alternative configurations enabled in various embodiments, the hardware implementing the method 700 is referred to herein as a “memory subsystem scan dump device.”

In block 702, the memory subsystem scan dump device may enable at least one component of the scan dump path. The memory subsystem scan dump device may receive a trigger to enable the at least one component of the scan dump path. The trigger may be received in response to identifying the condition for a memory subsystem scan dump described for block 502 of the method 500 with reference to FIG. 5. Enabling the at least one component of the scan dump path may include enabling a clock for the scan dump path and/or enabling at least one selective connection component (e.g., selective connection component 228, 230 in FIGS. 2A-2D) connecting the at least one scan dump logic module to an associated cache (e.g., cache 232 in FIGS. 2A-2D). Enabling the at least one component of the scan dump path may include setting one or more register values configured to indicate that the at least one component of the scan dump path is enabled. The one or more register values may be set, for example, at the memory registers (e.g., memory registers 214 in FIGS. 2A-2D), which may include at the scan dump secure registers (e.g., scan dump secure registers 216 in FIGS. 2A-2D). In some embodiments, the memory subsystem scan dump device enabling the at least one component of the scan dump path in block 702 may be the microcontroller (e.g., microcontroller 212 in FIGS. 2A-2D), the scan dump logic module (e.g., scan dump logic module 226 in FIGS. 2A-2D), and/or the cache and/or the memory and cache controller (e.g., memory and cache controller 220 in FIGS. 2A-2D).

In block 704, the memory subsystem scan dump device may clear at least one memory of the memory subsystem. The at least one memory of the memory subsystem may include at least one cache of the memory subsystem. The memory subsystem scan dump device may clear the at least one memory by overwriting data, including secure content, stored at the at least one memory. The memory subsystem scan dump device may overwrite data stored at the at least one memory with a constant value, a pattern of values, and/or random values, where any such values may include “0” and/or “1.” In some embodiments, the memory subsystem scan dump device clearing at least one memory of the memory subsystem in block 704 may be the microcontroller, the scan dump logic module and/or the memory and cache controller.

In block 706, the memory subsystem scan dump device may enable the scan dump NoC module (e.g., scan dump NoC module 210 in FIGS. 2A-2D). Enabling the scan dump NoC module may include setting a register value, such as at a register of the scan dump NoC module and/or the memory registers, which may include at the scan dump secure registers, configured to enable use and operation of the scan dump NoC module. In some embodiments, the memory subsystem scan dump device enabling the scan dump NoC module in block 706 may be the microcontroller, the scan dump logic module and/or the memory and cache controller.

In block 708, the memory subsystem scan dump device indicate that the scan dump path is enabled. The memory subsystem scan dump device may set and/or maintain a scan dump path enabled indicator configured to indicate that the scan dump path is enabled to implement a scan dump of memory subsystem cores. For example, the scan dump path ready indicator may be a register value set at the memory registers, which may include at the scan dump secure registers. In some embodiments, the scan dump path enabled indicator may be configured to indicate that the scan dump path is enabled to implement a scan dump of computing device component cores as well. In some embodiments, the memory subsystem scan dump device indicating that the scan dump path is enabled in block 708 may be the microcontroller, the scan dump logic module and/or the memory and cache controller.

In some embodiments any combination of blocks 702-708 may be implemented by the memory subsystem scan dump device following a cash of the computing device and during a crash reset flow for the computing device to recover from the crash.

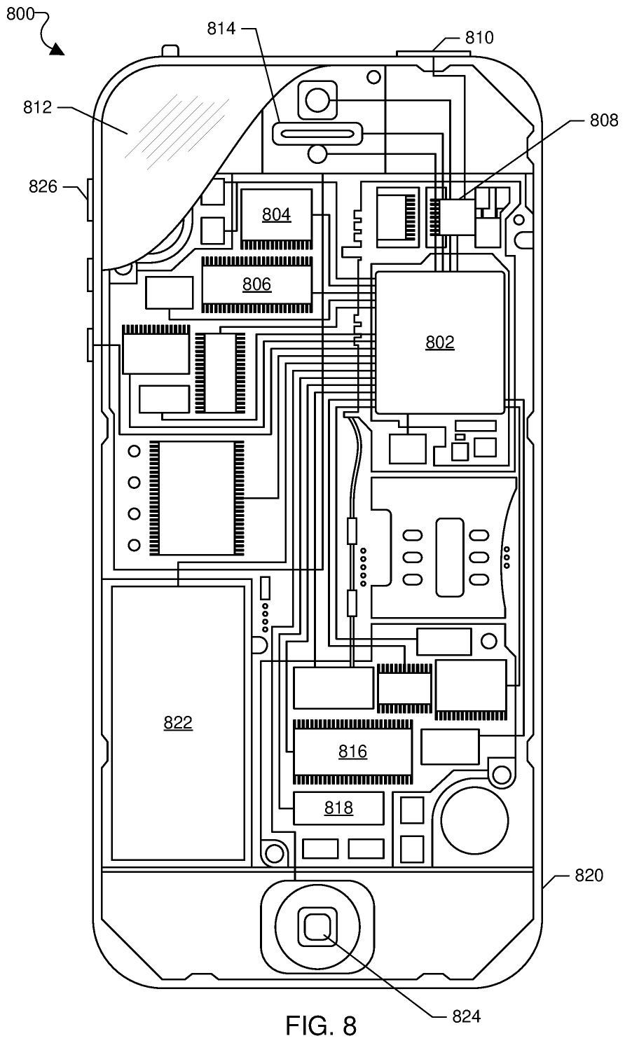

A system in accordance with the various embodiments (including, but not limited to, embodiments described above with reference to FIGS. 1-7) may be implemented in a wide variety of computing systems including mobile computing devices, an example of which suitable for use with the various embodiments is illustrated in FIG. 8. The mobile computing device 800 may include a processor 802 coupled to a touchscreen controller 804 and an internal memory 806. The processor 802 may be one or more multicore integrated circuits designated for general or specific processing tasks. The internal memory 806 may be volatile or non-volatile memory, and may also be secure and/or encrypted memory, or unsecure and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the mobile computing device 800 need not have touch screen capability.

The mobile computing device 800 may have one or more radio signal transceivers 808 (e.g., Peanut, Bluetooth, ZigBee, Wi-Fi, RF radio) and antennae 810, for sending and receiving communications, coupled to each other and/or to the processor 802. The transceivers 808 and antennae 810 may be used with the above-mentioned circuitry to implement the various wireless transmission protocol stacks and interfaces. The mobile computing device 800 may include a cellular network wireless modem chip 816 that enables communication via a cellular network and is coupled to the processor.

The mobile computing device 800 may include a peripheral device connection interface 818 coupled to the processor 802. The peripheral device connection interface 818 may be singularly configured to accept one type of connection, or may be configured to accept various types of physical and communication connections, common or proprietary, such as Universal Serial Bus (USB), FireWire, Thunderbolt, or PCIe. The peripheral device connection interface 818 may also be coupled to a similarly configured peripheral device connection port (not shown).

The mobile computing device 800 may also include speakers 814 for providing audio outputs. The mobile computing device 800 may also include a housing 820, constructed of a plastic, metal, or a combination of materials, for containing all or some of the components described herein. The mobile computing device 800 may include a power source 822 coupled to the processor 802, such as a disposable or rechargeable battery. The rechargeable battery may also be coupled to the peripheral device connection port to receive a charging current from a source external to the mobile computing device 800. The mobile computing device 800 may also include a physical button 824 for receiving user inputs. The mobile computing device 800 may also include a power button 826 for turning the mobile computing device 800 on and off.

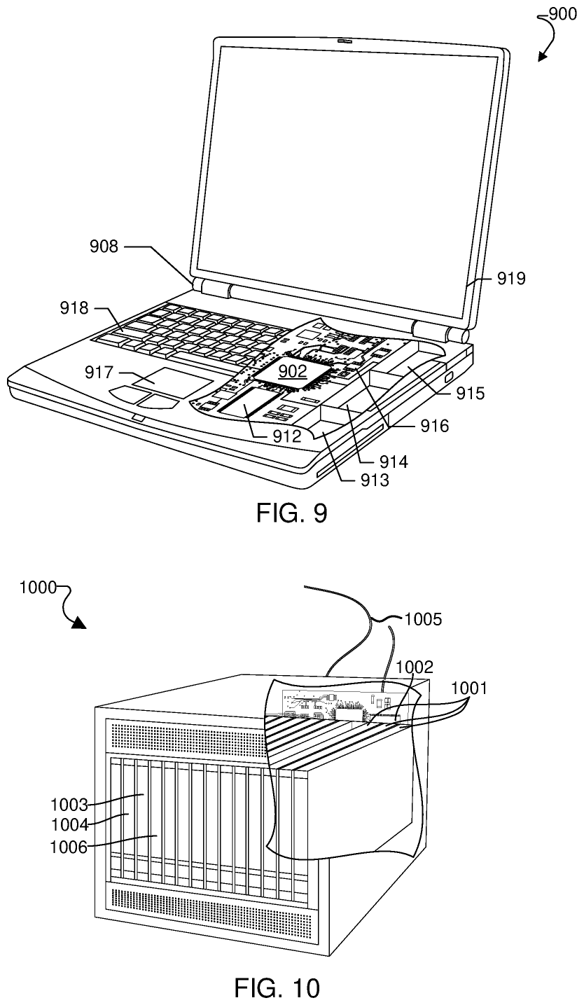

A system in accordance with the various embodiments (including, but not limited to, embodiments described above with reference to FIGS. 1-7) may be implemented in a wide variety of computing systems include a laptop computer 900, an example of which is illustrated in FIG. 9. Many laptop computers include a touchpad touch surface 917 that serves as the computer's pointing device, and thus may receive drag, scroll, and flick gestures similar to those implemented on computing devices equipped with a touch screen display and described above. A laptop computer 900 will typically include a processor 902 coupled to volatile memory 912 and a large capacity nonvolatile memory, such as a disk drive 913 of Flash memory. Additionally, the computer 900 may have one or more antenna 908 for sending and receiving electromagnetic radiation that may be connected to a wireless data link and/or cellular telephone transceiver 916 coupled to the processor 902. The computer 900 may also include a floppy disc drive 914 and a compact disc (CD) drive 915 coupled to the processor 902. In a notebook configuration, the computer housing includes the touchpad 917, the keyboard 918, and the display 919 all coupled to the processor 902. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-7) may also be implemented in fixed computing systems, such as any of a variety of commercially available servers. An example server 1000 is illustrated in FIG. 10. Such a server 1000 typically includes one or more multicore processor assemblies 1001 coupled to volatile memory 1002 and a large capacity nonvolatile memory, such as a disk drive 1004. As illustrated in FIG. 10, multicore processor assemblies 1001 may be added to the server 1000 by inserting them into the racks of the assembly. The server 1000 may also include a floppy disc drive, compact disc (CD) or digital versatile disc (DVD) disc drive 1006 coupled to the processor 1001. The server 1000 may also include network access ports 1003 coupled to the multicore processor assemblies 1001 for establishing network interface connections with a network 1005, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

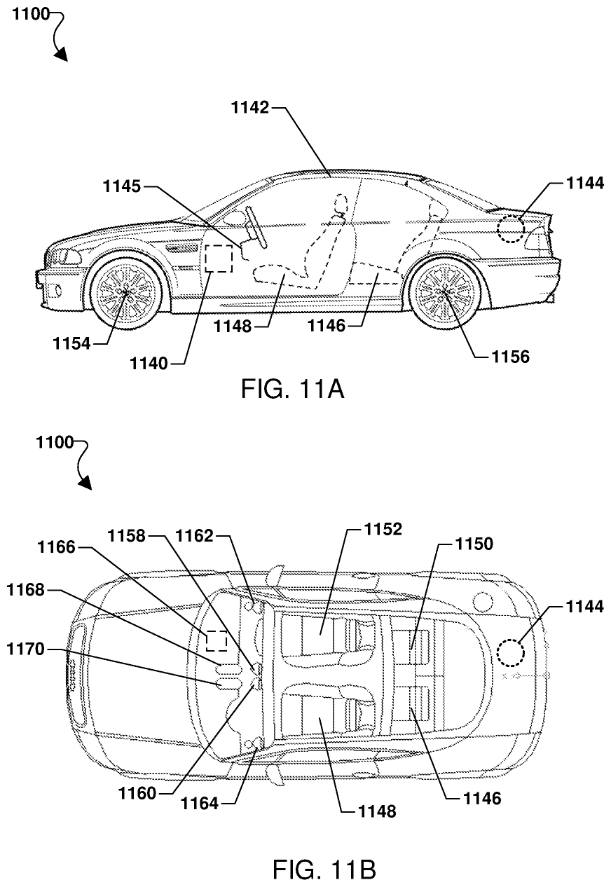

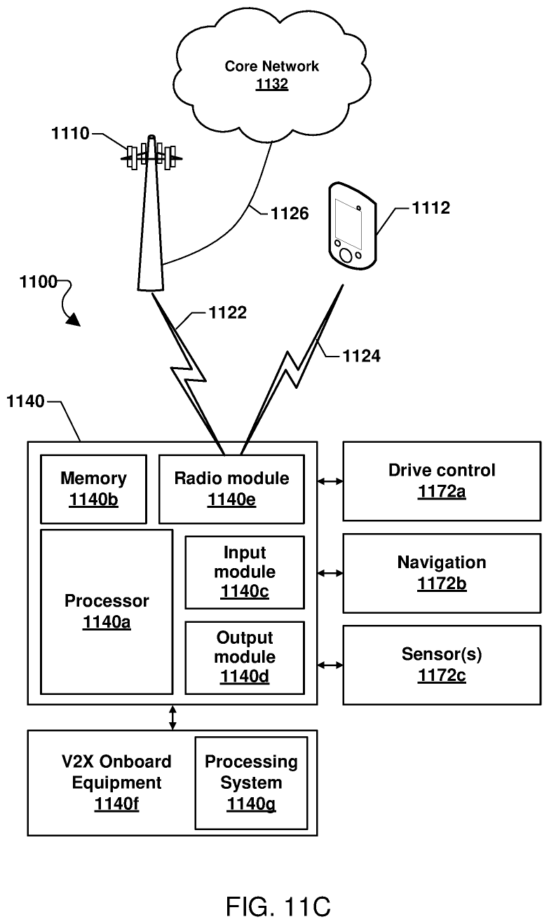

Methods and devices for implementing such methods in accordance with the various embodiments (including, but not limited to, embodiments described above with reference to FIGS. 1-7) may be implemented in a wide variety of computing systems including an embedded vehicle computing system 1100 an example of which is illustrated in FIGS. 11A-11C. An embedded vehicle computing system 1100 may include a vehicle control unit 1140, such as an ECU, which may include a processor, such as a CPU, an artificial intelligence (AI) processor, etc. The embedded vehicle computing system 1100 may include a plurality of sensors 1142-1170, including Global Navigation Satellite System (GNSS) receivers 1142, accelerometers 1144, occupancy sensors 1146, 1148, 1150, 1152, tire pressure sensors 1154, 1156, cameras 1158, 1160, microphones 1162, 1164, impact sensors 1166, external sensors 1168, 1170.

The plurality of sensors 1142-1170, disposed in or on the vehicle, may be used for various purposes, such as navigation, crash avoidance, etc., as well to provide sensor data regarding objects and people in or on the vehicle. The sensors 1142-1170 may include one or more of a wide variety of sensors capable of detecting a variety of information useful for navigation and collision avoidance. Each of the sensors 1142-1170 may be in wired or wireless communication with a control unit 1140, as well as with each other. In particular, the sensors may include one or more cameras 1158, 1160 or other optical sensors or photo optic sensors. The sensors may further include other types of object detection and ranging sensors, such as external sensors 1168, 1170, IR sensors, and ultrasonic sensors. The sensors may further include tire pressure sensors 1154, 1156, humidity sensors, temperature sensors, satellite GNSS receivers 1142, control input sensors 1145, accelerometers 1144, vibration sensors, gyroscopes, gravimeters, impact sensors 1166, force meters, stress meters, strain sensors, fluid sensors, chemical sensors, gas content analyzers, pH sensors, radiation sensors, Geiger counters, neutron detectors, biological material sensors, microphones 1162, 1164, occupancy sensors 1146, 1148, 1150, 1152, proximity sensors, and other sensors.

The vehicle control unit 1140 may include one or more processors configured with processor-executable instructions to perform navigation and collision avoidance operations using information received from various sensors, particularly the cameras 1158, 1160. In some embodiments, the control unit 1140 may supplement the processing of camera images using distance and relative position (e.g., relative bearing angle) that may be obtained from external sensors 1168, 1170. The control unit 1140 may further be configured to control steering, breaking and speed of the vehicle using information regarding other vehicles determined using various embodiments. The vehicle control unit 1140 may include one or more processors configured with processor-executable instructions to receive information from the sensors 1142-1170 and to perform operations using such information as further described herein. In various embodiments, the vehicle control unit 1140 may include, be a component of, or communicate with V2X onboard equipment of the vehicle.

FIG. 11C is a component block diagram illustrating the embedded vehicle computing system 1100 including components and support systems suitable for implementing various embodiments. The embedded vehicle computing system 1100 may include the control unit 1140, which may include various circuits and devices used to control the operation of the vehicle. The control unit 1140 may include a processor 1140a, such as a CPU, an AI processor, etc., a memory 1140b, an input module 1140c, an output module 1140d, and a radio module 1140e. The control unit 1140 may be coupled to and configured to control drive control components 1172a, navigation components 1172b, and one or more sensors 1172c of the embedded vehicle computing system 1100. The control unit 1140 may communicate with V2X onboard equipment 1140f. The processor 1140a may be configured with processor-executable instructions to control maneuvering, navigation, and/or other operations of the vehicle, including operations of various embodiments, including gathering and analyzing real-world vehicle run data gathered from the sensors 1172c. The processor 1140a may be coupled to the memory 1140b. The V2X onboard equipment 1140f may include one or more processors 1140g configured with processor-executable instructions to perform various operations of various embodiments, including communicating real-world vehicle run data gathered from the sensors 1172c between the embedded vehicle computing system 1140 and a wireless communication device 1112 and/or the computing device on a communication network (e.g., a core network 1132) via the radio module 1140e.

The radio module 1140e may be configured for wireless communication. The radio module 1140e may exchange signals (e.g., command signals for controlling maneuvering, signals from navigation facilities, data signals, etc.) via a communication link 1122 with a network transceiver (e.g., the base station 1110), and may provide the signals to the processor 1140a, 1140g and/or the navigation unit 1172b. In some embodiments, the radio module 1140e may enable the embedded vehicle computing system 1100 to communicate with a wireless communication device 1112 through the wireless communication link 1124. The wireless communication link 1124 may be a bidirectional or unidirectional communication link, and may use one or more communication protocols.

The input module 1140c may receive sensor data from one or more vehicle sensors 1172c as well as electronic signals from other components, including the drive control components 1172a and the navigation components 1172b. The output module 1140d may communicate with or activate various components of the embedded vehicle computing system 1100, including the drive control components 1172a, the navigation components 1172b, and the sensor(s) 1172c.

The control unit 1140 may be coupled to the drive control components 1172a to control physical elements of the vehicle related to maneuvering and navigation of the vehicle, such as the engine, motors, throttles, steering elements, flight control elements, braking or deceleration elements, and the like. The drive control components 1172a may also include components that control other devices of the vehicle, including interior environment controls (e.g., air conditioning and heating), external and/or interior lighting, interior and/or exterior informational displays (which may include a display screen or other devices to display information), safety devices (e.g., haptic devices, audible alarms, etc.), and other similar devices.

The control unit 1140 may be coupled to the navigation components 1172b, and may receive data from the navigation components 1172b and be configured to use such data to determine the present position and orientation of the vehicle, as well as an appropriate course toward a destination. The navigation components 1172b may include or be coupled to a GNSS receiver system (e.g., one or more Global Positioning System (GPS) receivers) enabling the embedded vehicle computing system 1100 to determine its current position using GNSS signals. Alternatively, or in addition, the navigation components 1172b may include radio navigation receivers for receiving navigation beacons or other signals from radio nodes, such as Wi-Fi access points, cellular network sites, radio station, remote computing devices, other vehicles, etc. Through control of the drive control elements 1172a, the processor 1140a may control the vehicle to navigate and maneuver. The processor 1140a, 1140g and/or the navigation components 1172b may be configured to communicate with a network element such as a server in a communication network (e.g., a core network 1132) via the wireless communication link 1122, 1126 to receive commands to control maneuvering, receive data useful in navigation, provide real-time position reports, etc.

The control unit 1140 may be coupled to one or more sensors 1172c. The sensor(s) 1172c may include the sensors 1142-1170 as described, and may the configured to provide a variety of data to the processor 1140a, 1140g.

While the control unit 1140 is described as including separate components, in some embodiments some or all of the components (e.g., the processor 1140a, the memory 1140b, the input module 1140c, the output module 1140d, and the radio module 1140e) may be integrated in a single device or module, such as an SoC processing device. Such an SoC processing device may be configured for use in vehicles and be configured, such as with processor-executable instructions executing in the processor 1140a, to perform operations of navigation and collision avoidance.

Implementation examples are described in the following paragraphs. While some of the following implementation examples are described in terms of example systems, devices, or methods, further example implementations may include: the example systems or devices discussed in the following paragraphs implemented as a method executing operations of the example systems or devices; the example systems, devices, or methods discussed in the following paragraphs implemented by a computing device comprising a processing device and/or a memory subsystem scan dump device configured with processing device-executable instructions to perform operations of the example systems, devices, or methods; the example systems, devices, or methods discussed in the following paragraphs implemented by a memory subsystem scan dump device configured to perform operations of the example systems, devices, or methods; the example systems, devices, or methods discussed in the following paragraphs implemented by a computing device comprising a memory subsystem scan dump device configured to perform operations of the example systems, devices, or methods; the example systems, devices, or methods discussed in the following paragraphs implemented by a computing device including means for performing functions of the example systems, devices, or methods; and the example systems, devices, or methods discussed in the following paragraphs implemented as a non-transitory processor-readable storage medium having stored thereon processor-executable instructions configured to cause a processor of a computing device to perform the operations of the example systems, devices, or methods.

Example 1. A method for implementing a scan dump of memory subsystem cores, including: enabling a scan dump path of the memory subsystem during a computing device crash reset flow, the scan dump path including at least one memory controller having at least one scan dump logic module, a scan dump network on chip (NoC) module, and at least one scan dump data bus connecting the at least one scan dump logic module and the scan dump NoC; and initializing a scan mode for a memory path of the memory subsystem and for a low power memory path of the memory subsystem.

Example 2. The method of example 1, further including storing scan chain data of at least one core of the memory subsystem to a memory of the memory subsystem during the computing device crash reset flow following enabling the scan dump path of the memory subsystem during the computing device crash reset flow.

Example 3. The method of either of example 1 or 2, further including: reading the scan chain data of at least one core of the memory subsystem during the computing device crash reset flow following enabling the scan dump path of the memory subsystem during the computing device crash reset flow; and writing the scan chain data for the at least one core of the memory subsystem to a memory of the memory subsystem via the scan dump path of the memory subsystem during the computing device crash reset flow.

Example 4. The method of example 3, in which: reading the scan chain data of the at least one core of the memory subsystem during the computing device crash reset flow following enabling the scan dump path of the memory subsystem during the computing device crash reset flow includes reading the scan chain data of the at least one core of the memory subsystem out of the memory subsystem; and writing the scan chain data for the at least one core of the memory subsystem to the memory of the memory subsystem via the scan dump path of the memory subsystem during the computing device crash reset flow includes writing the scan chain data for the at least one core of the memory subsystem to the memory of the memory subsystem via the scan dump path of the memory subsystem from out of the memory subsystem.

Example 5. The method of any of examples 1-4, further including clearing at least one memory of the memory subsystem.

Example 6. The method of example 5, further including indicating that the scan dump path is in an enabled state following enabling the scan dump path of the memory subsystem during the computing device crash reset flow and clearing the at least one memory of the memory subsystem.

Example 7. The method of any of examples 1-6, further including identifying a condition for a scan dump of the memory subsystem, in which enabling the scan dump path of the memory subsystem during the computing device crash reset flow may be implemented following identifying the condition for the scan dump of the memory subsystem.

Example 8. The method of any of examples 1-7, further including initializing a functional mode for the memory path of the memory subsystem and for the low power memory path of the memory subsystem while retaining scan chain data of at least one core of the memory subsystem at a memory of the memory subsystem.

Example 9. The method of any of examples 1-8, in which the memory subsystem cores includes at least one of at least one memory controller module, at least one cache controller module, a memory NoC module, a low power NoC module, at least one memory logic module, at least one low power logic module, or at least one cache.

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method for implementing a scan dump of memory subsystem cores, comprising:
enabling a scan dump path of the memory subsystem during a computing device crash reset flow, the scan dump path comprising at least one memory controller having at least one scan dump logic module, a scan dump network on chip (NoC) module, and at least one scan dump data bus connecting the at least one scan dump logic module and the scan dump NoC; and
initializing a scan mode for a memory path of the memory subsystem and for a low power memory path of the memory subsystem.

2. The method of claim 1, further comprising storing scan chain data of at least one core of the memory subsystem to a memory of the memory subsystem during the computing device crash reset flow following enabling the scan dump path of the memory subsystem during the computing device crash reset flow.

3. The method of claim 1, further comprising:
reading the scan chain data of at least one core of the memory subsystem during the computing device crash reset flow following enabling the scan dump path of the memory subsystem during the computing device crash reset flow; and
writing the scan chain data for the at least one core of the memory subsystem to a memory of the memory subsystem via the scan dump path of the memory subsystem during the computing device crash reset flow.

4. The method of claim 3, wherein:
reading the scan chain data of the at least one core of the memory subsystem during the computing device crash reset flow following enabling the scan dump path of the memory subsystem during the computing device crash reset flow comprises reading the scan chain data of the at least one core of the memory subsystem out of the memory subsystem; and
writing the scan chain data for the at least one core of the memory subsystem to the memory of the memory subsystem via the scan dump path of the memory subsystem during the computing device crash reset flow comprises writing the scan chain data for the at least one core of the memory subsystem to the memory of the memory subsystem via the scan dump path of the memory subsystem from out of the memory subsystem.

5. The method of claim 1, further comprising clearing at least one memory of the memory subsystem.

6. The method of claim 5, further comprising indicating that the scan dump path is in an enabled state following enabling the scan dump path of the memory subsystem during the computing device crash reset flow and clearing the at least one memory of the memory subsystem.

7. The method of claim 1, further comprising identifying a condition for a scan dump of the memory subsystem, wherein enabling the scan dump path of the memory subsystem during the computing device crash reset flow is implemented following identifying the condition for the scan dump of the memory subsystem.

8. The method of claim 1, further comprising initializing a functional mode for the memory path of the memory subsystem and for the low power memory path of the memory subsystem while retaining scan chain data of at least one core of the memory subsystem at a memory of the memory subsystem.

9. The method of claim 1, wherein the memory subsystem cores include at least one of at least one memory controller module, at least one cache controller module, a memory NoC module, a low power NoC module, at least one memory logic module, at least one low power logic module, or at least one cache.

10. A computing device, comprising:
a memory subsystem comprising:
a plurality of memory subsystem cores;
at least one memory controller having at least one scan dump logic module, at least one memory logic module, at least one low power logic module, and at least one cache;
a scan dump network on chip (NoC) module;
a memory path bus configured to connect a memory NoC module and the at least one memory logic module;
a low power memory path bus configured to connect a low power NoC module and the at least one low power logic module; and
a scan dump path bus configured to connect the scan dump NoC module and the at least one scan dump logic module; and
a microcontroller configured to:
enable a scan dump path of the memory subsystem during a computing device crash reset flow, the scan dump path comprising the at least one scan dump logic module, the scan dump NoC module, and the scan dump path bus; and
initialize a scan mode for a memory path of the memory subsystem and for a low power memory path of the memory subsystem, the memory path including the memory NoC module, the at least one memory logic module, and the memory path bus, and the low power memory path including the low power NoC module, the at least one low power logic module, and the low power memory path bus.

11. The computing device of claim 10, wherein the at least one scan dump logic module is configured to store scan chain data of at least one core of the memory subsystem to a memory of the memory subsystem during the computing device crash reset flow following enabling the scan dump path of the memory subsystem during the computing device crash reset flow.

12. The computing device of claim 10, further comprising a scan dump interface module connected to the plurality of memory subsystem cores via a scan path bus and configured to read the scan chain data of at least one core of the memory subsystem during the computing device crash reset flow following enabling the scan dump path of the memory subsystem during the computing device crash reset flow; and
wherein the scan dump NoC module is configured to write the scan chain data for the at least one core of the memory subsystem to a memory of the memory subsystem via the scan dump path of the memory subsystem during the computing device crash reset flow.

13. The computing device of claim 12, wherein
the scan dump interface module is further configured to read the scan chain data of the at least one core of the memory subsystem out of the memory subsystem; and
the scan dump NoC module is further configured to write the scan chain data for the at least one core of the memory subsystem to the memory of the memory subsystem via the scan dump path of the memory subsystem from out of the memory subsystem.

14. The computing device of claim 10, wherein the at least one scan dump logic module is configured to clear at least one memory of the memory subsystem.

15. The computing device of claim 14, wherein the microcontroller is further configured to indicate that the scan dump path is in an enabled state following enabling the scan dump path of the memory subsystem during the computing device crash reset flow and clearing the at least one memory of the memory subsystem.

16. The computing device of claim 10, wherein the microcontroller is further configured to identify a condition for a scan dump of the memory subsystem, wherein enabling the scan dump path of the memory subsystem during the computing device crash reset flow is implemented following identifying the condition for the scan dump of the memory subsystem.

17. The computing device of claim 10, wherein the microcontroller is further configured to initialize a functional mode for the memory path of the memory subsystem and for the low power memory path of the memory subsystem while retaining scan chain data of at least one core of the memory subsystem at a memory of the memory subsystem.

18. The computing device of claim 10, wherein the plurality of memory subsystem cores includes at least one of at least one memory controller module, at least one cache controller module, the memory NoC module, the low power NoC module, the at least one memory logic module, the at least one low power logic module, or the at least one cache.

19. A computing device, comprising:
means for enabling a scan dump path of a memory subsystem during a computing device crash reset flow, the scan dump path comprising at least one memory controller having at least one scan dump logic module, a scan dump network on chip (NoC) module, and at least one scan dump data bus connecting the at least one scan dump logic module and the scan dump NoC; and
means for initializing a scan mode for a memory path of the memory subsystem and for a low power memory path of the memory subsystem.

20. The computing device of claim 19, further comprising means for storing scan chain data of at least one core of the memory subsystem to a memory of the memory subsystem during the computing device crash reset flow following enabling the scan dump path of the memory subsystem during the computing device crash reset flow.

21. The computing device of claim 19, wherein the at least one core of the memory subsystem includes at least one of at least one memory controller module, at least one cache controller module, the memory NoC module, the low power NoC module, the at least one memory logic module, the at least one low power logic module, or the at least one cache.

22. The computing device of claim 19, further comprising:
means for reading the scan chain data of at least one core of the memory subsystem during the computing device crash reset flow following enabling the scan dump path of the memory subsystem during the computing device crash reset flow; and
means for writing the scan chain data for the at least one core of the memory subsystem to a memory of the memory subsystem via the scan dump path of the memory subsystem during the computing device crash reset flow.

23. The computing device of claim 22, wherein:
means for reading the scan chain data of the at least one core of the memory subsystem during the computing device crash reset flow following enabling the scan dump path of the memory subsystem during the computing device crash reset flow comprises means for reading the scan chain data of the at least one core of the memory subsystem out of the memory subsystem; and
means for writing the scan chain data for the at least one core of the memory subsystem to the memory of the memory subsystem via the scan dump path of the memory subsystem during the computing device crash reset flow comprises means for writing the scan chain data for the at least one core of the memory subsystem to the memory of the memory subsystem via the scan dump path of the memory subsystem from out of the memory subsystem.

24. The computing device of claim 19, further comprising means for clearing at least one memory of the memory subsystem.

25. The computing device of claim 24, further comprising means for indicating that the scan dump path is in an enabled state following enabling the scan dump path of the memory subsystem during the computing device crash reset flow and clearing the at least one memory of the memory subsystem.

26. The computing device of claim 19, further comprising means for identifying a condition for a scan dump of the memory subsystem, wherein means for enabling the scan dump path of the memory subsystem during the computing device crash reset flow is implemented following identifying the condition for the scan dump of the memory subsystem.

27. The computing device of claim 19, further comprising means for initializing a functional mode for the memory path of the memory subsystem and for the low power memory path of the memory subsystem while retaining scan chain data of at least one core of the memory subsystem at a memory of the memory subsystem.
